(19) United States
(12) Patent Application Publication
(10) Pub. No.: US 2018/0089617 A1
(43) Pub. Date: Mar. 29, 2018

(54) SYSTEMS AND METHODS FOR TRACKING WEAR OR USAGE OF COMMERCIAL PRODUCTS

(71) Applicant: Wal-Mart Stores, Inc., Bentonville, AR (US)

(72) Inventors: Todd D. Mattingly, Bentonville, AR (US); David Tovey, Rogers, AR (US)

(21) Appl. No.: 15/715,718

(22) Filed: Sep. 26, 2017

Related U.S. Application Data
(60) Provisional application No. 62/400,535, filed on Sep. 27, 2016.

(51) Int. Cl. G06Q 10/08; G06Q 30/06

(52) U.S. Cl. CPC G06Q 10/087; G06K 2017/0045; G06Q 30/06

(57) ABSTRACT

In some embodiments, apparatuses and methods are provided herein including: at least one user product with at least one passive sensor; at least one network reader configured to expose the user product to energy and measure reflections of the energy from the at least one passive sensor; and a control circuit operably coupled to the network reader. The control circuit configured to receive an initial signal reading of the at least one passive sensor from the network reader; save the initial signal reading in a user profile in a profile database; receive a reading of one or more reflections of the energy from the at least one passive sensor; and compare the reading of the one or more reflections with one or more profile readings associated with the at least one user product and the at least one passive sensor to determine a degree of wear of the user product.

This application claims the benefit of U.S. Provisional Application No. 62/400,535, filed Sep. 27, 2016, entitled SYSTEMS AND METHODS FOR TRACKING WEAR OR USAGE OF COMMERCIAL PRODUCTS (Attorney Docket No. 8842-138371-USPR_1302US01), which is incorporated by reference in its entirety herein.

### TECHNICAL FIELD

This invention relates generally to tracking wear or usage patterns, and more particularly, to tracking wear or usage patterns of commercial products.

### BACKGROUND

For certain commercial products, customers generally buy the product and then use it until the product fails or no longer works properly. Further, the products may sometimes fail at an inopportune time. For example, a customer may be on the way to an interview when the customer's shoe breaks or otherwise becomes damaged. In this example, the heel or the toe cap may have become separated from the shoe. In another example, a tennis racquet used by a tennis player during a final's match may suddenly fail due to one or more strings of the tennis racquet breaking, snapping, or otherwise separating from its rim. Accordingly, it would be desirable to monitor the products and upgrade, replace, or otherwise change the product (i.e., the shoes or the tennis racquet) before they break or fail at an inopportune time, which may add unnecessary stress to certain situations.

### BRIEF DESCRIPTION OF THE DRAWINGS

Disclosed herein are embodiments of systems, apparatuses and methods pertaining to tracking wear or usage patterns of one or more products. This description includes drawings, wherein:

FIG. 1 is an illustration of an exemplary schematic representation of a system for tracking wear or usage patterns in accordance with some embodiments;

FIG. 2 is an exemplary schematic illustration of a user product including one or more passive sensors and one or more unique product identifiers in accordance with several embodiments;

FIG. 3 is an exemplary flow diagram of the system in FIG. 1 in accordance with some embodiments;

FIG. 4 is another illustration of an exemplary schematic representation of a system for tracking wear or usage patterns in accordance with some embodiments;

FIG. 5 is an exemplary flow diagram of the system in FIG. 4 in accordance with some embodiments;

FIG. 6 illustrates an exemplary system for use in implementing systems, apparatuses, devices, methods, techniques, and the like in tracking wear or usage patterns in accordance with several embodiments; and

FIG. 7 is another illustration of an exemplary schematic representation of a system for tracking wear or usage patterns in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for tracking wear or usage patterns of one or more user products. In some embodiments, there is provided a product evaluation system including a user product with at least one passive sensor incorporated therein, at least one network reader, and a control circuit operably coupled to the network reader. The network reader may expose the user product to energy and measure reflections of the energy from the at least one passive sensor. In one approach, the control circuit may receive an initial signal reading of the at least one passive sensor from the network reader and save the initial signal reading of the at least one passive sensor in a user profile in a profile database. In another approach, the control circuit may receive an initial signal reading or setting from a product manufacturer or testing organization. The control circuit may also receive a second reading of one or more reflections of the energy from the at least one passive sensor from the at least one of network reader and compare the reading of the one or more reflections with one or more profile readings (measured by the network reader or received from another source) associated with the at least one user product and the at least one passive sensor to determine a degree of wear of the user product.

As used herein, the network reader may be configured to measure a signal strength of the passive sensors incorporated into the user product. Further, in one exemplary configuration, a unique product identifier is associated with the passive sensor incorporated into the user product and the network reader may be configured to obtain the unique product identifier associated with the passive sensor, in addition to measuring the signal strength of the passive sensor. By one approach, the passive sensor may include one or more RFID tags incorporated into a product and/or magnetic ink, among others. In addition, the network reader may include, for example, an RFID reader, a magnetic ink reader, and an image capturing device. The network reader may, for example, include a transceiver configured to transmit electromagnetic signal(s) and measure reflections of the electromagnetic signal(s) from a surface of the user product.

The products may include, for example, garments, footwear, sports equipment, and/or recreational equipment, among others. In one example, the passive sensor may include an RFID tag that is embedded in a tennis or athletic shoe, and as the shoe is used and a dielectric material around the passive RFID sensor is abraded away, the signal from the RFID tag will change. Accordingly, a signal strength of a passive sensor embedded in a dielectric material is generally measurable such that as the dielectric material is abraded away through use of the user product, the signal strength of the passive sensor gets stronger.

In yet another configuration, the at least one passive sensor includes one or more layers of sensing material that may be progressively abraded away from the user product through use thereof such that a signal strength of the at least one passive sensor (i.e., the layers of sensing material) gets weaker as the one or more layers of sensing material or a portion thereof are abraded away.

As noted above, the user product may include more than one passive sensors. Accordingly, a first passive sensor may be located in a first area of the user product and a second passive sensor may be located in or incorporated into the user product in a second area. The second passive sensor, which is located in the second area of the user product, is configured to help determine the degree of wear the user product has experienced at or corresponding to the second area of the user product.

In another exemplary embedment, the wear tracking system may include a database of reference signal strengths corresponding to usage states of the product that is associated with the unique product identifier. Further, in a configuration with a unique product identifier associated with the passive sensor, the control circuit may be configured to receive the unique product identifier with the readings of the reflections of the energy and compare the reading(s) with the reference signal strengths in the database to, in part a wear state of the user product based on the unique product identifier associated therewith. In addition, the control circuit may notify a user that a product replacement of the user product is warranted based on the reading of the one or more reflections of the passive sensor obtained by the network reader. The notification for the user regarding product replacement or product usage (e.g., a notice regarding the degree of wear a user product has experienced) may be provided to a user device, such as, for example, a smartphone, a computer, a display device, a database, or a server, among others.

Such a configuration may be particularly useful for recreational or other activities requiring a significant amount of equipment, gear, apparel, or other items. In this manner, a user may be able to scan a large amount of equipment, gear, or apparel at one time and receive an indication about the usage, strength, and/or life remaining in a number of products. In short, the readings can tell a user about the integrity of a number of different items in a short period of time. At that point, one or more product replacements and/or upgrades may be made after a notice of the states of the products is provided to an end user device.

In one illustrative approach, a shopping system for tracking use of products may include a plurality of user products, each having a unique product identifier associated therewith. The shopping system may include a network reader. The network reader may send energy to one of the user products and measure reflectance of the energy or a signal from the user product. The shopping system may also include a product database of unique product identifiers and various states of usage associated with each of the unique product identifiers calibrated to the reflectance of the energy or the signal measured by the network reader. The shopping system may also include a control circuit in communication with the network reader and the product database. The control circuit may receive a measurement of the reflectance or the signal from the network reader. The control circuit may also compare the measurement with calibrated states of usage in the product database and notify a user of degree of wear of the user product. The comparison of the measurement with calibrated states of usage determines whether replacement of the user product is warranted based on usage of the user product.

In another illustrative approach, a method for tracking usage may include maintaining a database of user products with a unique product identifier and a usage profile for the user products therein. The method may include calibrating particular usage profiles of particular products by exposing a particular one of the user products to directed energy and measuring a signal returned from the particular user products at various states of usage. The method also may include exposing a user product to directed energy and measuring a signal or reflectance returned from the user product. In addition, the method may include comparing the signal or reflectance returned from the user product with the usage profile in the database to determine whether replacement of the user product is warranted based on usage of the user product.

By one approach, the method may include incorporating a passive sensor into at least some of the user products in the database. The method also may include updating the database of user products and the associated usage profile of the particular one of the user products based on measurements obtained by measuring the signal or reflectance returned from the particular user products exposed to directed energy.

In yet another configuration, a product evaluation system may include a user product having a unique product identifier associated therewith, an image capturing device configured to capture an image of the user product, and a product database of reference images corresponding to states of usage of the user product that is associated with the unique product identifier. The product evaluation system may also include a control circuit operably coupled to the image capturing device and the product database of reference images. The control circuit may receive the image of the user product from the image capturing device and the unique product identifier associated with the user product and compare the product image with the reference images of the database of references images. The comparison of the product image with the reference images enables the control circuit to determine whether replacement of the user product is warranted based on usage of the user product. The control circuit may also notify a user that a product replacement of the user product is warranted based on the comparison of the product image with the reference images of the database of reference images.

In some configurations discussed herein, the image capturing device may be configured to shine an illuminating light at a surface of the user product and measure light reflectance form the user product. Once the images are captured, the control circuit, in some configurations, may update the product database of reference images to include the image of the user product received from the image capturing device. Depending on the database and system architecture, the product database may include a self-referential data structure.

In another exemplary embodiment, the system may include a cycle-counter circuit coupled to the control circuit. By one approach, the cycle-counter circuit (or a portion thereof) may be incorporated into the user product. In this manner, the cycle-counter circuit may be configured to count the number of impacts to a user product over a period of time. Additionally, the control circuit may be configured to correlate the number of impacts of the user product with the usage reference images of the user product. The control circuit also may correlate the number of images of the user product with the comparison between the product image(s) and the reference images. Further, the control circuit may store the correlation of the number of impacts with the reference images, the product images, and/or the comparison between the reference images and the product images. In addition, the control circuit may send a second notification to the user indicating the correlation along with the product image. In this manner, a user may be able to determine if their use is more or less intense than average such that they may plan their product replacement.

The product evaluation system also may have a charge-accumulator circuit coupled to the control circuit. By one approach, the charge-accumulator circuit, such as a piezoelectric material, is configured to store charge over a period of time. In this manner, the control circuit is configured to correlate the charge with the states of usage of the user product and the corresponding reference images over a period of time. Accordingly, the charge-accumulator circuit may determine whether the charge has reached a threshold and, in response to the charge reaching the threshold, send a signal to the control circuit indicating that the charge has reached the threshold. Furthermore, in response to receiving a signal indicating that the charge has reached the threshold, the system may notify the user that replacement of the use product is warranted. Such a notification may include, for example, a product replacement recommendation, a chart, a table, and/or a visualization illustrating the correlation of the charge over time with states of usage of the user product, the images (or enhanced images) of the used user product, and/or the corresponding reference images

By another approach, a method for tracking usage may include receiving a product image of a user product from an image capturing device and a unique product identifier associated with the user product. The method may include comparing the product image with reference images from a database of references images. The comparison of the product image with the reference images provides the ability to determine whether replacement of the user product is warranted based on usage of the user product, wherein the reference images correspond to states of usage of the user product. The method may also include notifying a user that a product replacement of the user product is warranted based on the comparison of the product image with the reference images of the database of reference images.

The method also may include receiving notice of a number of impacts to or experience by the user product, such as, for example, via a cycle counter. This information may then be correlated to the usage. For example, the method may further include correlating the number of impacts experienced by the user product with the stage or state of usage of the user product and the corresponding reference images over a period of time. This may be particularly useful for consumers interested in determining whether their usage is more or less extensive than other users. In one example, a parent may be notified that her child's shoe has had a certain number of impacts, which may be correlated with the user product image taken at the time of the evaluation (to associate the image with the number of impacts) and the reference image typical of shoes worn at that number of impacts. With this information, a parent may determine that the child is wearing or causing damage to the shoe that will results in requiring replacement much sooner than others. With this information, the parent may determine that alternative footwear are needed for certain activities. To provide up-to-date information, the product evaluation system will use the latest information from the cycle-counter circuit when the product images of the user product are captured, which will also be used when querying a database of reference images. In addition, once the product evaluation system identifies that the user product has reached a certain threshold of usage, such as by measuring the number of impacts to which the user product has been exposed, the product evaluation system may notify the user that replace of the user product is warranted.

A system is disclosed that enhances support at a retail store by identifying products used by customers that are potentially ready to be replaced. Ordinary persons skilled in the art recognize that the system is usable at various places, not just at the retail store. The system may use image processing, radio frequency identification (RFID) communication, and other methods to at least track or determine rate of wear (rate of usage) of products that customers are using in the retail store, such as clothes and shoes worn by customers. Based on the determined rate of wear, the system may notify a customer when the rate of wear reaches one or more thresholds (e.g., user-defined wear thresholds, manufacturer-defined thresholds, industry-based thresholds, predetermined thresholds, “worn out” thresholds, etc.). The system may also notify the customer a prediction of when the rate of wear is expected to reach the one or more thresholds. For example, image processing may be performed on images of the customer's jeans to identify wear patterns (e.g., in the knees, seat, etc.). The customer may be notified when the wear exceeds the one or more thresholds. The one or more thresholds indicate that it is time for the jeans to be replaced. By one approach, the system may be configured to automatically ship a replacement product upon detection of a predetermined threshold of wear or usage. By another approach, the system may be configured to prompt a user to order or accept an order for a replacement product upon detection of a predetermined threshold of wear or usage.

Similarly, images of the soles of the customer's shoes may be analyzed to determine the rate of wear of the shoes. The customer may be notified when the wear exceeds one or more thresholds. The retail store may include the RFID, where the RFID detects signals from one or more RFID tags/chips that may be embedded in the soles of shoes (or other products that are worn down over time or use). As the sole of the shoe (i.e., a dielectric material) is worn away, the signal from the RFID tag may become stronger thereby indicating that the shoe has undergone a certain amount of wear correlated to the increase in strength of the RFID signal. Further, the shoe may include multiple RFID tags in the soles or other portions of the shoes. This may permit the control circuit to obtain a more detailed picture of the wear or usage of the shoe. Other sensors at the retail store may detect a force distribution as a customer stands or walks across a surface. The resulting sensor data may be analyzed to determine the force distribution and detect when the distribution of forces is inconsistent with expected distribution of forces by more than one or more thresholds. One or more notifications are sent to the customer when the one or more thresholds are reached. The one or more notifications may also include at least one of one or more recommendations, advertisements, or incentives (e.g., discount). Some embodiments may also detect wear of store property, such as shopping cart wheels with embedded RFID tags that are inactive when one or more wheels are worn to a threshold level.

While the systems, methods, and apparatus described herein may be useful for retail facilities, users themselves may be quite interested in having up-to-date information regarding the usage and life left in their products. By one approach, a user may have a network reader, such as based RFID tag readers or scanners used in conjunction with a smartphone, and may regularly receive updates or assessments of their gear, such as footwear, clothing, or other personal items. Further, these regular readings may be saved in the user profile. In this manner, a user may analyze usage and wear history to determine when to replace items or to predict when replacement may be advisable. By predicting when replacement is advisable based on previous usage, a user is able to help prevent an item failing or breaking at an inopportune time.

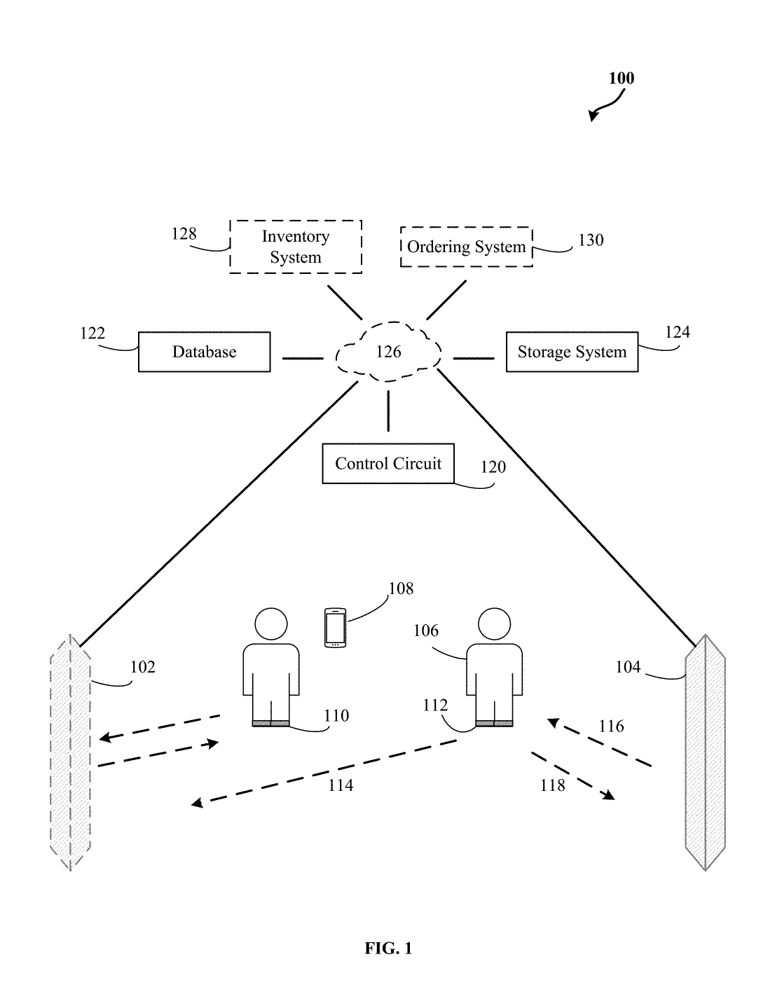

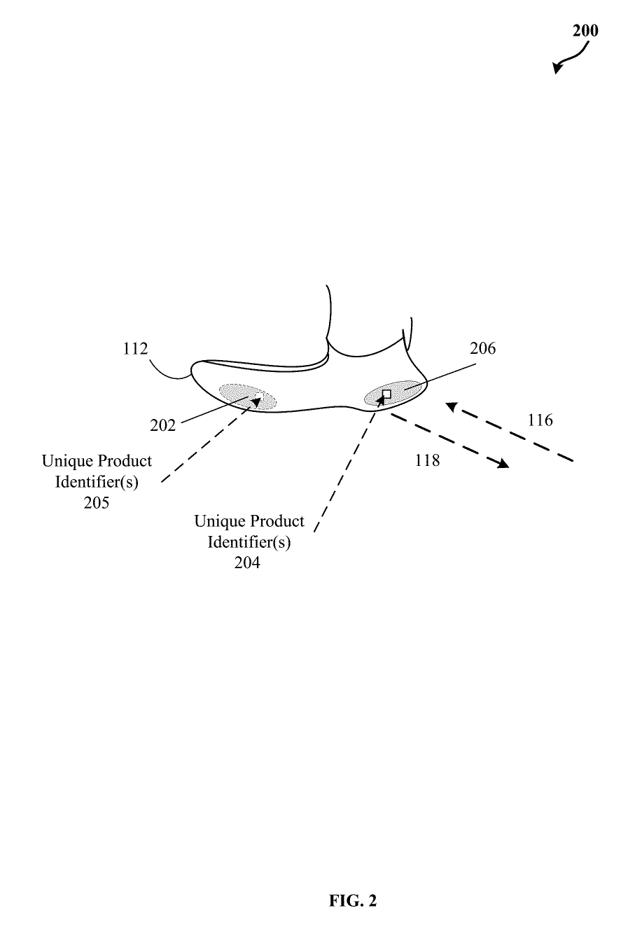

Reference will now be made simultaneously to FIG. 1 and FIG. 2. FIG. 1 illustrates an exemplary representation of a system 100 for tracking wear or usage, such as by identifying usage patterns, of one or more user products. FIG. 2 illustrates an exemplary user product 112 including one or more passive sensors 202, 206 and unique product identifiers 204, 205.

In FIG. 1, the system 100 includes a user product 112. The user product 112, in FIG. 1, is depicted as a footwear. However, the user product 112 may also include numerous different products, such as, for example, clothing, such as garments, sport equipment, and/or a recreational equipment, among many others. The user product 112 may include the first passive sensor 206 incorporated therein. The first passive sensor 206 may include one or more RFID (e.g., RFID tags or chips) or a magnetic ink layer, among others. For example, in one approach, the first passive sensor 206 may be a magnetic ink layer that creates a measurable inductance. As suggested above, the magnetic ink layer may be incorporated into or otherwise with footwear, garments, sports equipment, and/or recreational equipment. Accordingly, information regarding the integrity of the product having the ink incorporated therein may be derived from the magnetic ink.

By incorporating one or more passive sensors 202, 206 into a user product, the sensors may be manufactured into or with the user product. For example, when a user product 112 (or portions thereof) is manufactured, the passive sensor(s) 202, 206 may be molded, woven, attached, or otherwise incorporated into the product or material thereof. In one illustrative approach, the passive(s) 202, 206 sensor may be molded into a portion of the user product, such as the sole of a show. In another approach, such as clothing, the passive(s) 202, 206 sensor may be woven into the fabric forming the garment. In still yet another approach, the passive sensor(s) 202, 206 may be attached or applied to the user product after general formation of the product.

By one approach, each of the passive sensors 202, 206 has a unique product identifier associated therewith. For example, the unique product identifier 204 may be incorporated with or assigned to the first passive sensor 206. The unique product identifier 204 includes identifiable information particular to the user product 112 and the first passive sensor 206 associated with the unique product identifier 204. The unique product identifier 204 may also include another identifiable information particular to a customer 106. The user product 112 may also include a second passive sensor 202, which also may include a second unique product identifier 205 associated therewith. For example, when a network reader scans a user product having multiple passive sensors 202, 206 and obtains a reading of the signal strengths of each of the passive sensors 202, 206, the network reader also may obtain unique product identifiers for each of the passive sensors 202, 206 so that the network reader may determine the change of the signal strength over time for each of the passive sensors 202, 206 when comparing the signals from the passive sensors 202, 206 previously obtained.

In one implementation, the first passive sensor 206 may be embedded in a dielectric material that is abraded through use of the user product 112. For example, friction resulting from the customer 106 walking on a floor in the retail store causes abrasion of the dielectric material. Continual abrasion of the dielectric material causes signal strength of reflections of energy 118 from the first passive sensor 206 to increase over time. Alternatively, the first passive sensor 206 may also include one or more layers of sensing material that are progressively abraded away from the user product 112 through use thereof, such that the signal strength of the first passive sensor 206 gets weaker as the one or more layers of sensing material or a portion thereof are abraded away. In another implementation, the first passive sensor 206 may include the dielectric material that gets abraded over time causing signal strength of the reflections of the energy 118 to increase over time; while the second passive sensor 202 may include a dielectric material that when it gets abraded over time causes signal strength of the reflections of the energy from the second passive sensor 202 to get weaker. For example, a material configured to and/or adapted to block signal or signal strength of the reflections of the energy 118 may be abraded resulting in a gradual strengthening of the signal and/or signal strength of the reflections. In another example, the material, once abraded, may produce a strong signal and/or signal strength of the reflections. In one configuration, the material may include a material that may block reflection of an optical signal, a radio frequency signal, or a particular signal in the electromagnetic spectrum. In another example, the material may include a material other than a dielectric rubber sole.

In another implementation, the first passive sensor 206 may be located in a first area of the user product 112. The second passive sensor 202 may be located in a second area of the user product 112. Each of the passive sensors 202, 206 may determine for each respective location a degree of wear of the user product 112. In another implementation, a control circuit 120 may send a notification to a device 108 indicating the degree of wear of the user product 112 based on signals received from the passive sensors 202, 206 obtained via the network reader. The device 108 may include at least one of a smartphone, a computer, a display device, a database, or a server.

As illustrated in FIG. 1, the system 100 may include a first network reader 104. In use, the first network reader 104 may expose the user product 112 to energy 116. Reflections of the energy 118 from the first passive sensor 206 associated with the user product 112 may be measured by the first network reader 104. The system 100 also may include a second network reader 102 that may also measure reflections of the energy 114 from the first passive sensor 206. At least one of the first network reader 104 or the second network reader 102 may include at least one of an RFID reader, a magnetic ink reader, or an image capturing device. For example, the first or second network readers 102, 104 may obtain the unique product identifiers 204, 205 associated with the passive sensors 202, 206, along with measuring the strength of the reflected signal. The first and/or second network readers 102, 104 also may include a transceiver configured to transmit electromagnetic signal and measure reflections of the electromagnetic signal from a surface of the user product 112. As illustrated, at least one of the first network reader 104 or the second network reader 102 may expose energy and receive reflections of the energy from a second user product 110 in addition to the user product 112. In this manner, the network readers 102, 104 may be scanning and measuring numerous passive signals during a given time period.

The system 100 may also include the control circuit 120 operably coupled to the first and second network readers 102, 104. By one approach, the network readers 102, 104 may be handheld devices, mounted in store location permitting use by users, such as at a kiosk, or mounted in store in a location permitting scanning of whatever user products are brought within the network range, among other configurations. For example, in one illustrative approach, if the customer 106 wearing the user product 112 walks into the retail store and passes the first network reader 104, the first network reader 104 may expose the user product 112 to the energy 116 and measures the reflections of the energy 118 from the first passive sensor 206. The first passive sensor 206 is incorporated in the user product 112. The measurement of the reflections of the energy 118 may correspond to a measurement by the first network reader 104 of a signal strength reflected from the first passive sensor 206. The second network reader 102 may also expose the user product 112 to another set of energy and measures energy reflections from the first passive sensor 206. Energy reflections from the second passive sensor 202 may also be measured by at least one of the first network reader 104 or the second network reader 102.

In yet another approach, the network readers 102, 104 may be handheld devices that may be used upon request by a user. In this manner, if the customer walks into a shoe store and is interested in determining how much life or usage is left in a particular pair of shoes, the shoes may be scanned with one or more network readers 102, 104 to obtain a signal reading.

In one implementation, the control circuit 120 may receive, from the first or second network readers 102, 104, a first signal reading of the passive sensors 202, 206. The first signal reading of the passive sensor 202, 206 may be saved by the control circuit 120 in a user profile of a profile database. The profile database may be included in a database 122. The database 122 may correspond to a master database coupled to a plurality of specialized databases. For example, the plurality of specialized databases may include at least one of the profile database, a database of reference signal strengths, a product database, a database of user products, a product database of reference images, and/or a product database of unique product identifiers and various states of usage, among others.

By one approach, the product database of unique product identifiers and various states of usage is associated with a plurality of unique product identifiers. In one approach, one or more of a plurality of network readers are calibrated to capture the reflectance of energy or signal strength of one or more of the plurality of the RFID tags and/or the unique product identifiers. In one illustrative approach, the database of reference signal strengths may include a plurality of reference signal strengths. Each of the plurality of reference signal strengths may correspond to a particular state of usage of a particular user product.

In one approach, each user product may be associated with a particular unique product identifier. In addition to a particular user product, the unique product identifiers may identify the type of user product and/or the particular sensor associated with the unique product identifier, among other information. In this manner, if a user product has more than one passive sensor, the unique product identifier may identify the product itself and the passive sensor emitting the signals.

In operation, a second signal reading of the reflections of the energy 118 from the first passive sensor 206 may be received by the control circuit 120 from the first network reader 104 (such as after the user has worn or used the user product for a period of time). The control circuit 120 may compare the second signal reading of the reflections 118 with one or more profile readings associated with the user product 112 to determine a degree of wear of the user product 112 (and potentially the likely additional life, wear, or usage left in the product before replacement, servicing, or repair are recommended). In an illustrative non-limiting example, the one or more profile readings associated with the user product 112 may be stored in the database of user products. By one approach, the database of user products may include a plurality of user products, a plurality of reflections associated with a plurality of degree of wear, and/or a plurality of threshold levels of degree of wear that may trigger notifications. For example, the control circuit 120 may provide notification when, based on an access to the database of user products, a sole of a shoe has reach a particular threshold of the plurality of threshold levels of degree of wear. By one approach, the particular threshold may include 50% remaining active life of a user product, 0% remaining active life of the user product, and/or any intermediate percentage between 0% to 50% and/or 50% to 100% remaining active life of the user product. By assessing the wear of the user product, via a comparison of the second signal reading and a previous first signal reading, a user will be able to ascertain how quickly they are actually wearing through the life of the user product. In another implementation, the control circuit 120 may receive the unique product identifier 204 with the second signal reading and compare the second signal reading with the reference signal strengths in the database of reference signal strengths (and possibly the likely additional life) to determine a wear state of the user product 112 based on the unique product identifier 204. By assessing the wear of the user product via a comparison between the second signal reading and a database of readings, a user will be able to obtain information about the usage of the product even if they have not previous scanned the product to obtain a reference signal. For example, in situations where the user starts using the product prior to assessment or exposure to a network reader (e.g., the first or second network readers 102, 104) the signal may be compared with signals in the database 122.

The control circuit 120 may also notify the customer 106 (i.e., user of the user product 112) that a product replacement of the user product 112 is warranted based on the reading of the reflections 118 of the passive sensor(s), such as first and/or second passive sensors 202, 206, obtained by a network reader, such as the first and/or second network readers 102, 104). Such a notification may be sent to a user via a user device, such as a handheld device such as a smartphone or table device, an installed or mounted device, such as a store kiosk or point of sale terminal, among other such devices. By one approach, the customer notification may be based on a user-defined wear threshold. In one example, the user-defined wear threshold may indicate a customer preference for at least a level of usage of product and/or a degree of wear of the product that the customer wants to be notified of replacement and/or to place an order for a replacement. As such, for example, a user may be notified to place an order of a user product when a determination is made by the control circuit 120 that a replacement of the user product is warranted based on usage of the user product and/or a degree of wear of the user product being at least equal to a user-defined wear threshold. In another example, the control circuit 120 may automatically place the order based on at least a user-defined preference (e.g., wear thresholds, notification preferences set by the user, etc.).

In another configuration, the system 100 also may include an inventory system 128. By one approach, the control circuit 120 may recommend a particular product based on a determination of a similarity of the particular product with the user product 112, via such the inventory system 128. In addition, the control circuit 120 may receive an order from the customer 106 and send an order request to an ordering system 130. The order request may indicate that an order for the particular product has been submitted and relevant information about the order sufficient for processing of the order. The order request may have been initiated automatically based on the customer's 106 order. In addition, a customer's order may be submitted or initiated automatically based on a customer setting or manually by the customer. The customer 106 may use the device 108 to communicate with the control circuit 120 to place the order. In response to the communication, the control circuit 120 may store the order in a storage system 124. The storage system 124 may include at least one of an internal storage device, an external storage device, or a cloud-based storage device. The control circuit 120 may be coupled to at least one of the database 122, the inventory system 128, the ordering system 130, or the storage system 124 via a network 126.

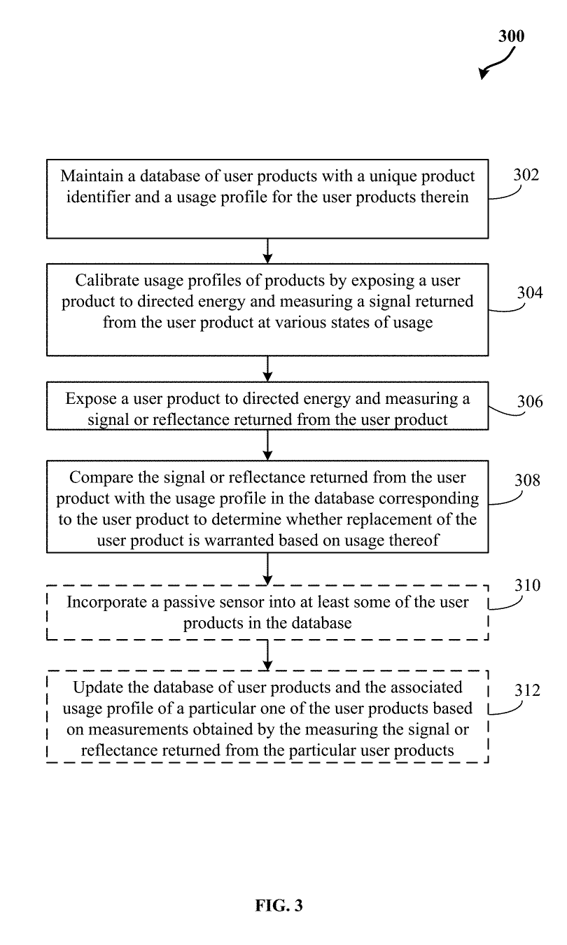

FIG. 3 illustrates a flow diagram of an exemplary method 300 for tracking wear or usage patterns of one or more user products. The exemplary method 300 may be implemented in the system 100 of FIG. 1. The method 300 includes, at step 302, maintaining a database of user products having unique product identifiers and usage profiles. For example, the database of user products may correspond to the database 122 of FIG. 1. The control circuit 120 of FIG. 1 may maintain the database of user products. The user products 110, 112 of FIG. 1 and their corresponding usage profiles also may be included in the database of the user products. The unique product identifiers associated with the first passive sensor 206 and the second passive sensor 202 may also be included in the database of the user products. At step 304, particular usage profiles are calibrated by exposing a particular one of the user products to directed energy and measuring a signal returned from the particular user product at various states of usage. For example, the control circuit 120 and a network reader or other similar device may calibrate the particular usage profiles. In one illustrative approach, the database of the user products includes a plurality of usage profiles.

The method 300 also may include exposing a user product to directed energy and measuring a signal or reflectance returned from the user product, at step 306. For example, the directed energy may correspond to the energy 116 of FIGS. 1 and 2. The signal returned from the particular user product may correspond to the reflections of the energy 118 of FIGS. 1 and 2. At step 308, the signal or reflectance returned from the user product is compared with the usage profile in the database to determine whether replacement of the user product is warranted based on usage of the user product. In another implementation, the method 300 may include incorporating a passive sensor into at least some of the user products in the database, at step 310. The method 300 may also include, at step 312, updating the database of user products and the associated usage profile of the particular one of the user products based on measurements obtained by the measurement of the signal or reflectance returned from the particular user products.

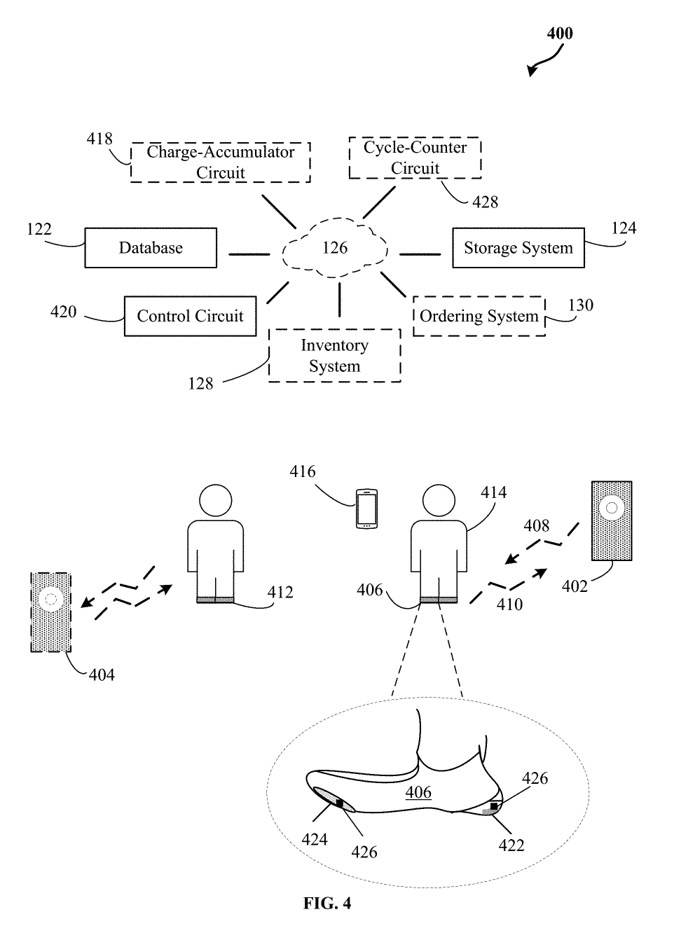

Referring to FIG. 4 which illustrates an exemplary representation of a system 400 for tracking wear or usage patterns. The system 400 may include a user product 406 including a unique product identifier 426. The system 400 may also include a second user product 412. Although, both the first and second user products 406, 412 are depicted as footwear, this disclosure is applicable to other types of user products. For example, as mentioned above, at least one of the user product 406 or the second user produce 412 may include at least one of a garment, sports equipment, and recreational equipment.

The system 400 may include one or more image capturing devices 402, 404. For example, the first image capturing device 402 may be used to manually or automatically capture an image of the user product 406. The first image capturing device 402 or the second image capturing device 404 may include, for example, a retail security camera, a camera on a smartphone, a standalone camera, a surveillance camera, and/or a camera associated with the network reader 102, 104 of FIG. 1, among others. In one implementation, the first image capturing device 402 may shine an illuminating light 408 at a surface of the user product 406 and measure reflected light, such as light reflectance 410, from the user product 406.

The system 400 may also include a product database of reference images. Database 122, shown in FIG. 1, may include such a product database of reference images. In one configuration, the database 122 may correspond to a master database that is coupled to a plurality of specialized databases. The product database of reference images may include a self-referential data structure. By one approach, the product database of reference images associates or correlates images of products to states of usage of the user product 406. In one illustrative approach, the usage states and images are associated according to the unique product identifier 426 (or a portion thereof). In use, the product database of reference images may be updated to include an image of the user product 406 that is received from the first image capturing device 402. In this manner, the user may subsequently be able to compare product images with previous images captured.

As shown in FIG. 4, the system 400 may include a control circuit 420 operably coupled to at least one of the first image capturing device 402 or the second image capturing device 404 and the product database of reference images, such as the database 122. The control circuit 420 may receive the image of the user products (such as the user product 406) from the image capturing devices 402, 404. When the control circuit 420 receives the images, the images may have an identifier, such as the unique product identifier 426, associated or correlated therewith. As the unique product identifier 426 is associated with the user product 406, these images also are associated with the user product 406 via the unique product identifier 426.

The control circuit 420 also may compare the product image(s) with the reference images of the database of reference images to determine whether replacement of the user product 406 is warranted based on usage of the user product 406. For example, the product image may be of a shoe having a heel that is made of different layers. The layers may correspond to different material or color patterns. As the heel wears during repeated use thereof, the patterns or layers of the heel are abraded 422. The control circuit 420 may compare an image of the shoe showing the remaining layers of the heel with one or more reference images from the database of reference images. The control circuit 420 may determine that a reference image corresponding to a heel requiring replacement corresponds to the image of the shoe showing remaining layers left in the heel. In operation, the control circuit 420 may not only analyze the exposure of certain layers of the heel material, but also pattern of abrasion. For example, if a small portion of a heel or sole of a shoe is being abraded at a much faster pace than the remainder thereof, the product may become unstable despite much of the remainder of the product being relatively unchanged from initial wear. Similarly, an outsole of the user product 406 may show a second pattern of abrasion 424.

Following a comparison of the product images, the control circuit 420 may notify a customer 414 (i.e., a user of the user product 406) that a product replacement of the user product 406 is warranted based on the comparison. The notification may be delivered in a number of manners including those described above.

The system 400 may also include a cycle-counter circuit 428 coupled to the control circuit 420. By one approach, the cycle-counter circuit 428 (or a portion thereof) may be incorporated into one or more user product(s). The cycle-counter circuit 428 may count number of impacts to the user product 406 over a period of time. In one illustrative example, the user product may include a portion of the cycle-counter circuit 428 such that the on-board portion of the cycle-counter circuit 428 tracks or measures the impacts, strikes, or uses that the shoe, garment, or equipment has experienced. In another configuration, the number of impacts may manifest as the pattern of abrasions 422, 424. The number of impacts to the user product 406 may be correlated with the states of usage of the user product 406 by the control circuit 420. The control circuit 420 may also store the correlation using the storage system 124. In an exemplary implementation, the control circuit 420 may correlate the number of impacts to the user product 406 with the states of usage of the user product 406 using corresponding reference images over the period of time.

The first image capturing device 402 or the second image capturing device 404 may include, for example, a retail security camera, a camera on a smartphone, a standalone camera, a surveillance camera, and/or a camera associated with the network reader (e.g., the first or second network readers 102, 104 of FIG. 1), among others.

The image capturing devices 402, 404 may be camera, such, as for example, retail security cameras, smartphone cameras, standalone cameras, surveillance camera, and/or cameras associate with network readers 102, 104, among others. In one embodiment, the image capturing devices 402, 404 may be mounted in a physical retail shopping facility, such as near an entrance. For example, when the customer 414 walks within or into the retail store, the first image capturing device 402 may capture an image of the user product 406. Furthermore, the control circuit 420 receives the image along with the unique product identifier 426 that is associated with the user product 406. The image shows that the user product 406 has a particular pattern of abrasion 422. The particular pattern of abrasion 422 may show that only few of the remaining layers of the heel are left on the user product 406.

After receiving the image(s) of the user product, the control circuit 420 compares the image(s) with one or more reference images of the database of reference images. The one or more reference images show different stages of wear or stages of usage for the user product 406 or a user product similar to the user product 406. In addition, the control circuit 420 may receive information from the cycle-counter circuit 428. In this manner, the control circuit 420 may determine that the user product has experienced a certain number of impacts counted (via information from the cycle-counter circuit 428) that may correspond to a range of usage values. Based on a range of usage, the control circuit 420 may determine that the user product requires replacement in a certain time frame. The range of values may be associated with impact ratings for the user product 406. In this manner, the control circuit 420 may be using evidence of the exterior wear of the user product by analyzing the abraded surfaces and/or the structural wear of the user product by analyzing the impacts measure via the cycle-counter circuit 428 to determine whether replacement of the user product is warranted.

The control circuit 420 correlates the image with the one or more reference images of the database of reference images and with the determined number of impacts experienced by the user product 406. The control circuit 420 determines whether replacement of the user product 406 is warranted based on the correlation. The control circuit 420 may send a notification to the customer 414 indicating the correlation along with the image.

The system 400 also may include a charge-accumulator circuit 418 coupled to the control circuit 420. By one approach, the charge-accumulator circuit 418 (or a portion thereof) may be incorporated into one or more user product(s). The charge-accumulator circuit 418 may store charge over a period of time. For example, the charge-accumulator circuit 418 may store a charge each time the user product 406 makes an impact on a floor or a surface. In one exemplary approach, the charge-accumulator circuit 418 includes a piezoelectric material. The control circuit 420 may correlate the charge (or the amount of number of charges) with the states of usage of the user product 406 and the corresponding reference images over the period of time. The charge-accumulator circuit 418 may determine whether the charge has reached a threshold. In one configuration, the charge-accumulator circuit 418 may include an energy storage device (e.g., battery, capacitor, etc.). In such a configuration, the piezoelectric material may charge the energy storage device each time the user product 406 makes an impact on a floor or a surface. As such, energy is accumulated in the energy storage device. By one approach, the accumulated energy is used to measure an amount of wear and determine the states of usage of the user product 406. In a non-limiting illustrative example, a one (1) joule of stored energy in the energy storage device may correspond to one hundred (100) impacts of the user product 406 on a floor or a surface which may also correspond to a particular unit value of wear. By one approach, the database 122 of FIG. 1 may include associations of energy measured and number of impacts with unit value of wear for a reference user product and/or each user product of a plurality of user products. In another configuration, the energy storage device may be periodically discharged (e.g., using a light emitting diode (LED) or any other type of device capable of discharging the energy storage device when coupled to the energy storage device) in response to a determination by the control circuit 420 of current accumulated energy of the energy storage device. Alternatively or in addition to, the charge-accumulator circuit 418 may provide power to a signaling device and/or a receiving device (e.g., one or more sensors. LEDs, or the like). By one approach, the energy storage device may be coupled to the signaling device and/or the receiving device to discharge the charge-accumulator circuit 418. Alternatively or in addition to, the signaling device and/or the receiving device may send and/or receive an indication of stored charge (e.g., stored energy of the energy storage device) or usage and/or wear of a user product as a percentage or factor compared to a “worn out” threshold. In an illustrative non-limiting example, a different frequency signal may correspond to each particular voltage value of a plurality of voltage values corresponding to the stored charge or to each level of a plurality of levels of usage and/or wear of a user product. In another illustrative non-limiting example, a different color may be emitted by an LED based on the frequency signal corresponding to the stored charge, the usage, and/or the wear of the user product.

In response to the charge reaching the threshold, the charge-accumulator circuit 418 may send a signal to the control circuit 420 indicating that the charge has reached the threshold. In response to receiving the signal, the control circuit 420 may notify the customer 414 that a product replacement of the user product 406 is warranted. In another implementation, the control circuit 420 may send a notification to the customer 414 indicating that a product replacement of the user product 406 is warranted based on the comparison of the product image with the reference images of the database of reference images and the receipt of the signal from the charge-accumulator circuit 418 indicating that the charge has reached the threshold. The notification may include a suggested replacement product, a chart and/or a table showing the correlation of the charge over the period of time with the states of usage of the user product 406, images of the user product and/or the corresponding reference images, among other information.

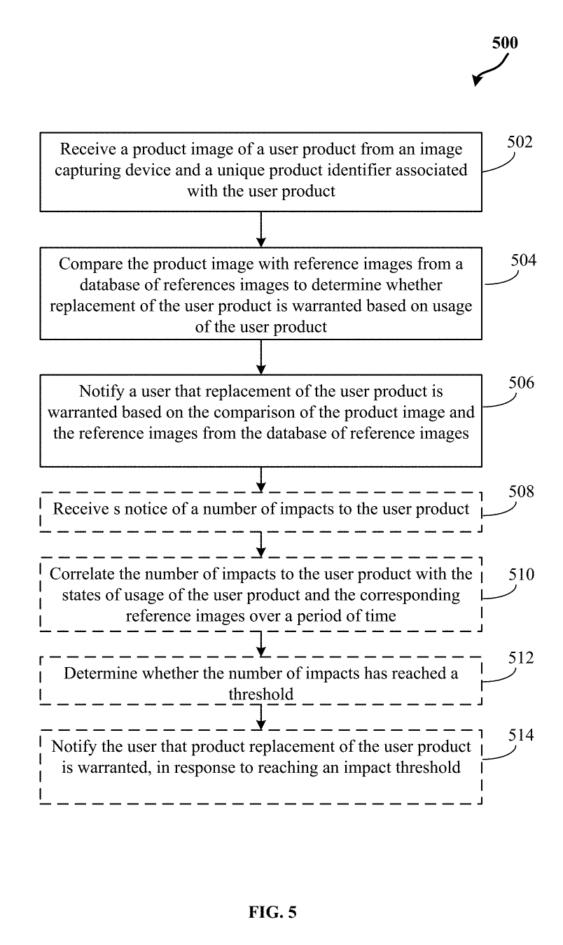

FIG. 5 illustrates a flow diagram of an exemplary method 500 of tracking wear or usage patterns of one or more user products. The exemplary method 500 may be implemented in the system 400 of FIG. 1. The method 500 may include receiving a product image of a user product from an image capturing device and a unique product identifier associated with the user product, at step 502. For example, the control circuit 420 may receive a product image of the user product 406. At step 504, comparing the product image with reference images of a database of references images to determine whether replacement of the user product is warranted based on usage of the user product, where the reference images correspond to states of usage of the user product 406. The database of reference images may correspond to the database 122. At step 506, notifying the customer 414 that a product replacement of the user product 406 is warranted based on the comparison of the product image with the reference images of the database of reference images. In some implementations, a device may be notified, alternatively or in addition to, the customer 414.

In another implementation, the method 500 may include, at step 508, receiving notice of a number of impacts to the user product 406. For example, the control circuit 420 may receive the number of impacts from the cycle-counter circuit 428. At step 510, the method 500 may include correlating the number of impacts to the user product 406 with the states of usage of the user product 406 and the corresponding reference images over a period of time. The control circuit 420 may store the correlation in the storage system 124.

At step 512, the method 500 may include determining whether the number of impacts has reached a certain pre-determined threshold. At step 514, in response to the number of impacts reaching the threshold, the method 500 may include further notifying the user that product replacement is warranted. In another implementation, the control circuit 420 may determine one or more products to suggest as a replacement for the user product 406 or to determine if the same user product is available using the inventory system 128. The control circuit 420 may send a signal ordering the replacement using the ordering system 130, if such a feature is selected by the user. In this manner, the user product monitoring and replacement may be automated such that a user may not need to manually submit a product replacement order each time a product is needed. The control circuit 420 may be coupled to at least one of the database 122, the charge-accumulator circuit 418, the cycle-counter circuit 428, the storage system 124, the ordering system 130, or the inventory system 128 via the network 126.

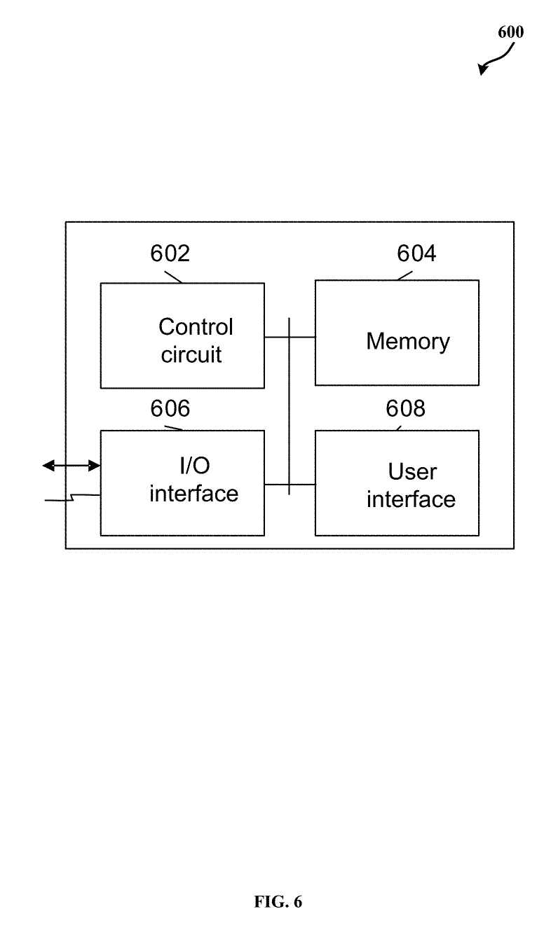

The methods, techniques, systems, devices, services, servers, sources and the like described herein may be utilized, implemented and/or run on many different types of devices and/or systems. Referring to FIG. 6, there is illustrated a system 600 that may be used for any such implementations, in accordance with some embodiments. One or more components of the system 600 may be used to implement any system, apparatus or device mentioned above, or parts of such systems, apparatuses or devices, such as for example any of the above or below mentioned control circuits, image capturing devices, point of sale terminals, associate devices, databases, devices, network readers, parts thereof, and the like. However, the use of the system 800 or any portion thereof is certainly not required.

By way of example, the system 600 may include one or more control circuits 602, memory 604, and input/output (I/O) interfaces 606. Some embodiments further include one or more user interfaces 608. The control circuit 602 typically comprises one or more processors and/or microprocessors. The memory 604 stores the operational code or set of instructions that is executed by the control circuit 602 and/or processor to implement the functionality of the systems and devices described herein, parts thereof, and the like. In some embodiments, the memory 604 may also store some or all of particular data that may be needed to analyze images of store shelves and determine whether restocking is need or whether the store shelves closely resembled the planogram.

It is understood that the control circuit 602 and/or processor may be implemented as one or more processor devices as are well known in the art. Similarly, the memory 604 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 604 is shown as internal to the system 600; however, the memory 604 can be internal, external or a combination of internal and external memory. Additionally, the system typically includes a power supply (not shown), which may be rechargeable, and/or it may receive power from an external source. While FIG. 6 illustrates the various components being coupled together via a bus, it is understood that the various components may actually be coupled to the control circuit 602 and/or one or more other components directly.

Generally, the control circuit 602 and/or electronic components of the system 600 can comprise fixed-purpose hard-wired platforms or can comprise a partially or wholly programmable platform. These architectural options are well known and understood in the art and require no further description here. The system and/or control circuit 602 can be configured (for example, by using corresponding programming as will be well understood by those skilled in the art) to carry out one or more of the steps, actions, and/or functions described herein. In some implementations, the control circuit 602 and the memory 604 may be integrated together, such as in a microcontroller, application specification integrated circuit, field programmable gate array or other such device, or may be separate devices coupled together.

The I/O interface 606 allows wired and/or wireless communication coupling of the system 600 to external components and/or or systems. Typically, the I/O interface 606 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 608 may be used for user input and/or output display, such as a display of a point of sale terminal, the network readers 102, 104, or the user device 108. For example, the user interface 608 may include any known input devices, such one or more buttons, knobs, selectors, switches, keys, touch input surfaces, audio input, and/or displays, etc. Additionally, the user interface 608 include one or more output display devices, such as lights, visual indicators, display screens, etc. to convey information to a user, such as but not limited to communication information, status information, notifications, errors, conditions, and/or other such information. Similarly, the user interface 608 in some embodiments may include audio systems that can receive audio commands or requests verbally issued by a user, and/or output audio content, alerts and the like.

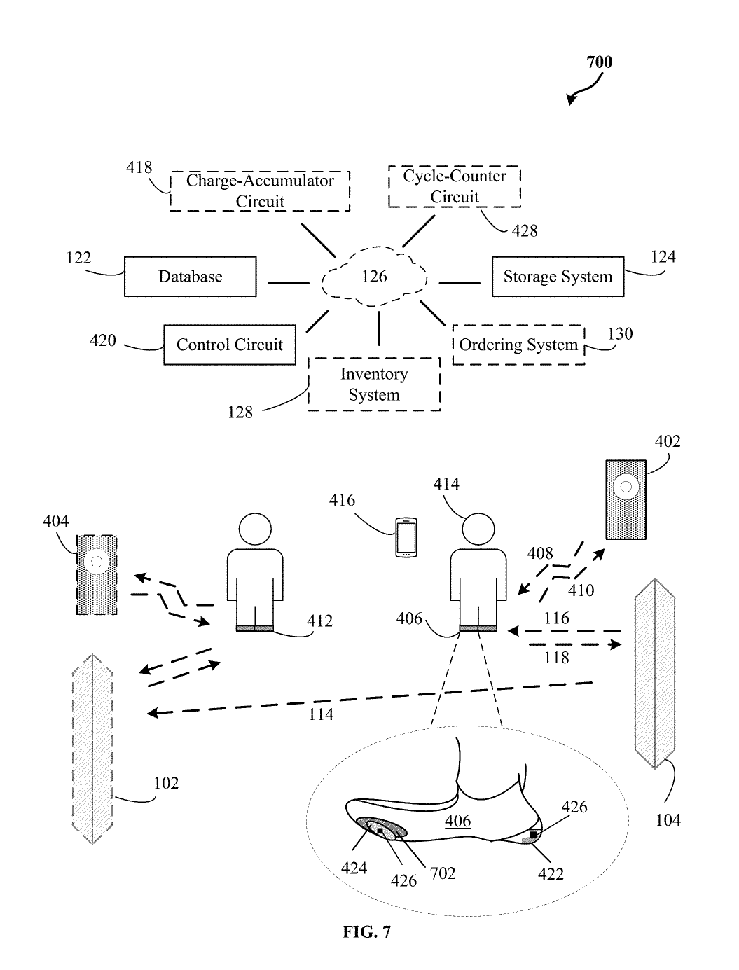

In some configurations, a system may use both imaging analytics and passive sensors to track wear or usage of a user product. FIG. 7 shows an exemplary schematic illustration of a system 700 including network readers 102, 104 and image capturing devices 402, 404. Accordingly, both the network readers 102, 104 and the image capturing devices 402, 404 may be used to track wear or usage of the user products 406, 412. The control circuit 420 may be operably coupled to the first and second network readers 102, 104 and the image capturing devices 402, 404. In some embodiments, the network readers may be able to scan passive sensors and capture images such that an image capturing device is incorporated into the network readers 102, 104 discussed above. During use, measurements from the passive sensor(s) and the captured images may be combined or used together to provide a more detailed analysis of the product wear or usage. Alternatively, in other configurations, the measurements from the sensors and the captured images may be used independently of the other to ascertain a degree of wear or usage, such as for example, when one of the measurements is not available.

In one illustrative approach, if the customer 414 wearing the user product 406 walks into the retail store and passes the first network reader 104, the first network reader 104 may expose the user product 406 to the energy 116 and measure the reflections of the energy 118 from a passive sensor 702 incorporated into the user product 406. In another configuration, the customer 414 may have the user product 406 (and any passive sensors incorporated therein) scanned (i.e., exposed to energy 116 and energy reflectance 118 measured) at a time convenient for the customer 414. By one approach, the measurement of the reflected energy 118 typically corresponds to the signal strength of the passive sensor 702 as measured by the first network reader 104. The second network reader 102 may also expose the user product 406 to another set of energy and measure energy reflections from the passive sensor 702. As discussed above, more than one passive sensor may be incorporated into the user products. As illustrated in FIG. 7, the passive sensor 702 may include the unique product identifier 426. When the user product 406 is scanned, the network readers 102, 104 may determine the extent of the usage or a pattern of abrasion 424 of the user product 406 by measuring the strength of the passive sensor 702. Further, when images of the user product 406 are captured and compared with reference images, the extent of usage or a pattern of abrasion 424 may be determined.

By one approach, the user product 406 is scanned via a network reader 102, 104 around the time that the image capturing devices 402, 404 capture images of the user product 406. In this manner, the user product 406 may be periodically evaluated by the strength of the signal from the passive sensor and the analysis of the captured images (as compared to reference images). In one illustrative approach, the user product 406 may be evaluated by image analysis of the user product 406 or by readings of the passive sensors 702 in between other readings. For example, in between trips to a retail facility to have the user product 406 scanned by a network reader 102, 104, a customer may capture images of the user product 406 on a mobile device that may be added to their user profile or compared with other images to provide additional information on the progression of wear or usage. In this manner, a user may obtain up-to-date information about product wear or usage in between readings of the passive sensors incorporated into the user product 406.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A product evaluation system comprising:
at least one user product with at least one passive sensor incorporated therein;
at least one network reader configured to expose the at least one user product to energy and measure reflections of the energy from the at least one passive sensor; and
a control circuit operably coupled to the at least one network reader, the control circuit configured to:
receive an initial signal reading of the at least one passive sensor from the at least one network reader;
save the initial signal reading of the at least one passive sensor in a user profile in a profile database;
receive a reading of one or more reflections of the energy from the at least one passive sensor from the at least one network reader; and
compare the reading of the one or more reflections with one or more profile readings associated with the at least one user product and the at least one passive sensor to determine a degree of wear of the at least one user product.

2. The product evaluation system of claim 1, wherein the at least one network reader is further configured to measure a signal strength of the at least one passive sensor.

3. The product evaluation system of claim 1, further comprising a unique product identifier associated with the at least one passive sensor incorporated into the at least one user product, wherein the at least one network reader is further configured to obtain the unique product identifier associated with the at least one passive sensor incorporated into the user product.

4. The product evaluation system of claim 3, further comprising a database of reference signal strengths corresponding to states of usage of the at least one user product associated with the unique product identifier.

5. The product evaluation system of claim 4, wherein the control circuit is further configured to receive the unique product identifier with the reading of the one or more reflections of the energy and compare the reading with the reference signal strengths in the database to determine a wear state of the at least one user product based on the unique product identifier associated therewith.

6. The product evaluation system of claim 5, wherein the control circuit is further configured to notify a user that a product replacement of the at least one user product is warranted based on the reading of the one or more reflections of the at least one passive sensor obtained by the at least one network reader.

7. The product evaluation system of claim 1, wherein the at least one passive sensor comprises at least one of: one or more RFID tags and magnetic ink.

8. The product evaluation system of claim 7, wherein the at least one network reader comprises at least one of: an RFID reader, a magnetic ink reader, and an image capturing device.

9. The product evaluation system of claim 8, wherein the at least one network reader comprises a transceiver configured to transmit electromagnetic signal and measure reflections of the electromagnetic signal from a surface of the at least one user product.

10. The product evaluation system of claim 1, wherein the at least one user product comprises at least one of: a garment, footwear, sports equipment, and recreational equipment.

11. The product evaluation system of claim 1, wherein a signal strength of the at least one passive sensor is measurable, the at least one passive sensor embedded in a dielectric material that is abraded through use of the at least one user product such that the signal strength of the at least one passive sensor gets stronger as the dielectric material is abraded from the at least one user product.

12. The product evaluation system of claim 1, wherein the at least one passive sensor includes one or more layers of sensing material that are progressively abraded away from the at least one user product through use thereof such that a signal strength of the at least one passive sensor gets weaker as the one or more layers of sensing material or a portion thereof are abraded away.

13. The product evaluation system of claim 1, wherein the at least one passive sensor is located in a first area of the at least one user product, and further comprising a second passive sensor incorporated with the at least one user product, the second passive sensor located in a second area of the at least one user product to determine the degree of wear of the at least one user product corresponding to the second area.

14. The product evaluation system of claim 1, wherein the control circuit is further configured to send a notification to a device indicating the degree of wear of the at least one user product, wherein the device comprises at least one of a smartphone, a computer, a display device, a database, or a server.

15. The product evaluation system of claim 1, wherein the control circuit is further configured to notify a user to order the at least one user product when the degree of wear reaches a user-defined wear threshold.

16. A shopping system for tracking use of products comprising:
a plurality of user products, each of the user products having a unique product identifier associated therewith;
a network reader configured to send energy to one of the user products and measure reflectance of the energy or a signal from the one of the user products;
a product database of unique product identifiers and various states of usage associated with each of the unique product identifiers calibrated to the reflectance of the energy or the signal measured by the network reader; and
a control circuit in communication with the network reader and the product database, the control circuit configured to:
receive a measurement of the reflectance or the signal from the network reader;
compare the measurement with calibrated states of usage in the product database to determine whether replacement of the one of the user products is warranted based on usage of the one of the user products; and
notify a user of degree of wear of the one of the user products.

17. The shopping system of claim 16, wherein the network reader comprises at least one of: an RFID reader, a magnetic ink reader, and an image capturing device.

18. The shopping system of claim 16, wherein the user product includes at least one of: at least one passive sensor incorporated therein and one or more layers of sensing material.

19. The shopping system of claim 16, wherein the control circuit is further configured to send a replacement order of the one of the user products based on the degree of wear being at least equal to a user-defined wear threshold.

20. A method comprising:
maintaining a database of user products with a unique product identifier and a usage profile for the user products therein;
calibrating particular usage profiles of particular products by exposing a particular one of the user products to directed energy and measuring a first signal returned from the particular one of the user products at various states of usage;
exposing a user product to the directed energy and measuring a second signal or reflectance returned from the user product; and
comparing the second signal or the reflectance returned from the user product with the usage profile in the database to determine whether replacement of the user product is warranted based on usage of the user product.

21. The method of claim 20, further comprising incorporating a passive sensor into at least some of the user products in the database.

22. The method of claim 20, further comprising updating the database of user products and associated usage profile of the particular one of the user products based on measurements obtained by the measuring the first signal or reflectance returned from the particular one of the user products.

23. The method of claim 20, further comprising notifying a user to order the user product when a determination that the replacement of the user product is warranted based on the usage of the user product being at least equal to a user-defined wear threshold.
